(19) United States
(12) Patent Application Publication
(10) Pub. No.: US 2009/0152756 A1
(43) Pub. Date: Jun. 18, 2009

(54) Phase Transition Pharmaceutical Mold For Producing Pellets For Injection Device

(76) Inventors: Cesario Dos Santos, Aliso Viejo, CA (US); Michael Morelli, San Francisco, CA (US)

Correspondence Address: ALCON, IP LEGAL, TB4-8, 6201 SOUTH FREEWAY, FORT WORTH, TX, 76134, US

(21) Appl. No.: 11/954,890

(22) Filed: Dec. 12, 2007

(51) Int. Cl. B29C 39/02; B29C 33/02; B29C 33/20

(52) U.S. Cl. 264/162; 249/119; 425/135; 425/218

(57) ABSTRACT

A mold assembly includes a mold base plate and a mold. The mold base plate has a bottom plate located in a recess. The mold can be inserted into and removed from the recess and is located on top of the bottom plate. The mold has a first section that is separable from a second section. When the first section and the second section are located adjacent to each other in the recess, a plurality of cavities is formed, each cavity for receiving a quantity of a drug and compound mixture when the mold base plate and mold are at a temperature other than room temperature

### BACKGROUND OF THE INVENTION

The present invention relates to dosing an injection device and more particularly to a mold for a drug suspended in a phase transition compound.

Several diseases and conditions of the posterior segment of the eye threaten vision. Age related macular degeneration (ARMD), choroidal neovascularization (CNV), retinopathies (e.g., diabetic retinopathy, vitreoretinopathy), retinitis (e.g., cytomegalovirus (CMV) retinitis), uveitis, macular edema, glaucoma, and neuropathies are several examples.

These, and other diseases, can be treated by injecting a drug into the eye. Such injections are typically done manually using a conventional syringe and needle. FIG. 1 is a perspective view of a prior art syringe used to inject drugs into the eye. In FIG. 1, the syringe includes a needle 105, a luer hub 110, a chamber 115, a plunger 120, a plunger shaft 125, and a thumb rest 130. As is commonly known, the drug to be injected is located in chamber 115. Pushing on the thumb rest 130 causes the plunger 120 to expel the drug through needle 105.

In using such a syringe, the surgeon is required to pierce the eye tissue with the needle, hold the syringe steady, and actuate the syringe plunger (with or without the help of a nurse) to inject the fluid into the eye. Fluid flow rates are uncontrolled. The volume injected is typically not controlled in an accurate manner because reading the vernier is subject to parallax error. Tissue damage may occur due to an “unsteady” injection.

An effort has been made to control the delivery of small amounts of liquids. A commercially available fluid dispenser is the ULTRA™ positive displacement dispenser available from EFD Inc. of Providence, R.I. The ULTRA dispenser is typically used in the dispensing of small volumes of industrial adhesives. It utilizes a conventional syringe and a custom dispensing tip. The syringe plunger is actuated using an electrical stepper motor and an actuating fluid. Parker Hannifin Corporation of Cleveland, Ohio distributes a small volume liquid dispenser for drug discovery applications made by Aurora Instruments LLC of San Diego, Calif. The Parker/Aurora dispenser utilizes a piezo-electric dispensing mechanism. Ypsomed, Inc. of Switzerland produces a line of injection pens and automated injectors primarily for the self-injection of insulin or hormones by a patient. This product line includes simple disposable pens and electronically-controlled motorized injectors.

U.S. Pat. No. 6,290,690 discloses an ophthalmic system for injecting a viscous fluid (e.g. silicone oil) into the eye while simultaneously aspirating a second viscous fluid (e.g. perflourocarbon liquid) from the eye in a fluid/fluid exchange during surgery to repair a retinal detachment or tear. The system includes a conventional syringe with a plunger. One end of the syringe is fluidly coupled to a source of pneumatic pressure that provides a constant pneumatic pressure to actuate the plunger. The other end of the syringe is fluidly coupled to an infusion cannula via tubing to deliver the viscous fluid to be injected.

When a portable hand piece is used to inject a drug into the eye, it is important to provide a proper drug dosage. In one case, a phase transition compound or reverse gelation compound contains the drug. At room temperature, these compounds are in a solid state and have the consistency of wax. Because of their consistency, dosing an injector with these compounds can be difficult. The compounds can be brought to a more liquid state and drawn into the injector. However, this is a time consuming process that may not provide proper dosage. Plugs can be made by bringing the compounds to a more liquid state and pouring them into a mold. After the compounds return to a solid state, they can be removed from the mold and placed in the injector. If the mold is properly designed, then a reliable dosage results.

### SUMMARY OF THE INVENTION

In one embodiment consistent with the principles of the present invention, the present invention is a mold assembly that includes a mold base plate and a mold. The mold base plate has a bottom plate located in a recess. The mold can be inserted into and removed from the recess and is located on top of the bottom plate. The mold has a first section that is separable from a second section. When the first section and the second section are located adjacent to each other in the recess, a plurality of cavities is formed, each cavity for receiving a quantity of a drug and compound mixture when the mold base plate and mold are at a temperature other than room temperature.

In another embodiment consistent with the principles of the present invention, the present invention is mold assembly that includes a mold base plate, a mold, first and second heaters, a retention device, and a scraper. The mold base plate has a bottom plate located in a recess. The mold can be inserted into and removed from the recess and is located on top of the bottom plate. The mold has a first section that is separable from a second section. The first heater heats the mold base plate. The retention device holds the mold in the recess. The mounting holes are for mounting the retention device on the mold base plate. The temperature controlled scraper is slidable over a top surface of the mold. The second heater is coupled to and heats the scraper. When the first section and the second section are located adjacent to each other in the recess, a plurality of cavities is formed, each cavity for receiving a quantity of a drug and compound mixture when the mold base plate and mold are heated.

In another embodiment consistent with the principles of the present invention, the present invention is a method of making drug/compound pellets comprising: heating a mold assembly; heating a mixture of a drug and phase transition compound; after the mixture has become more liquid, pouring the mixture into the mold; cooling the mold so that the mixture becomes more solid; drawing a heated scraper across the top surface of the mold; and removing finished pellets from the mold.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying figures, which are incorporated in and constitute a part of this specification, illustrate several embodiments of the invention and together with the description, serve to explain the principles of the invention.

FIG. 1 is a perspective view of a prior art syringe.

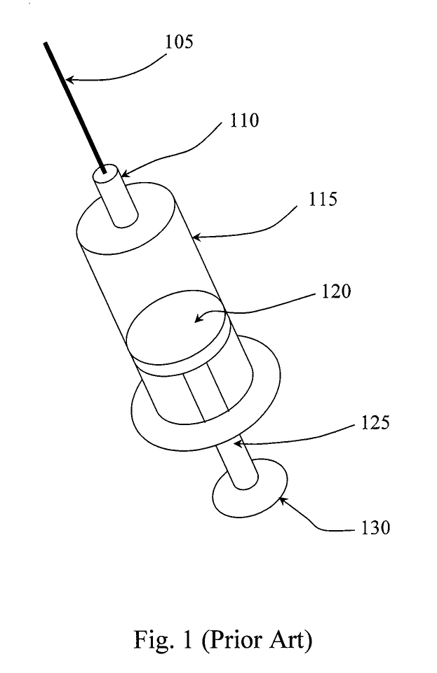

FIG. 2 is a cross section view of a disposable tip segment and a limited reuse assembly according to the principles of the present invention.

FIGS. 3A and 3B are perspective and end views of a mold base plate according to the principles of the present invention.

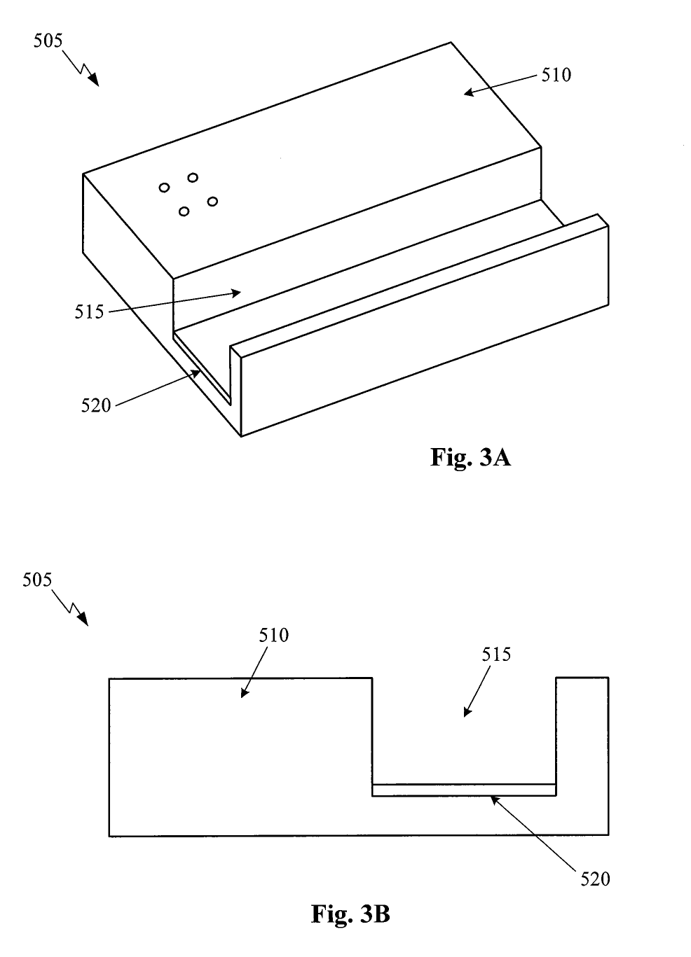

FIGS. 4A and 4B are perspective views of a mold according to the principles of the present invention.

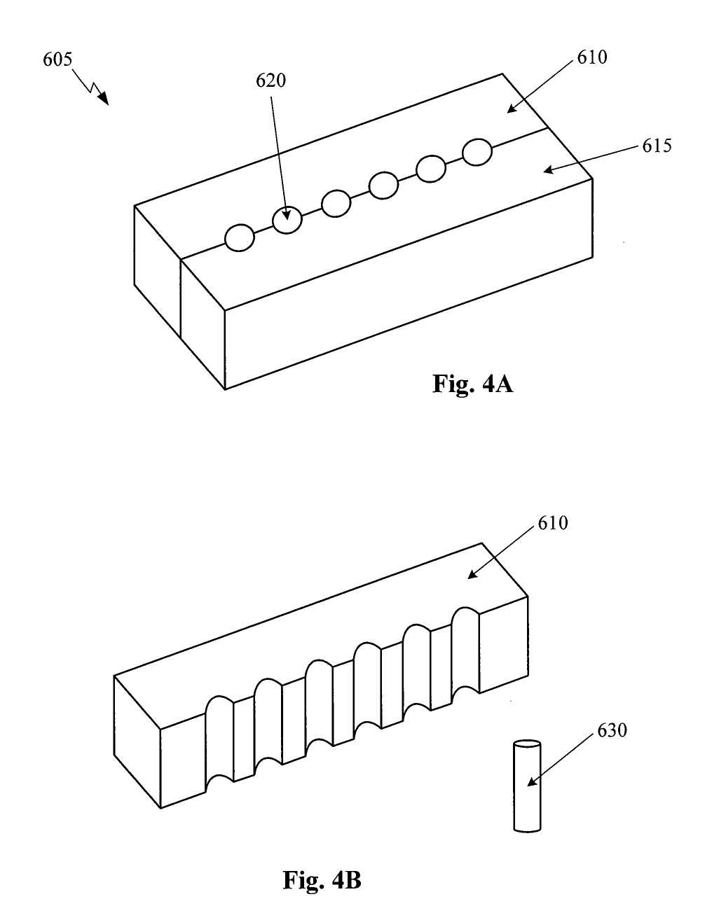

FIG. 5 is a perspective view of mold assembly according to the principles of the present invention.

FIG. 6 is a flow chart of a method of molding pellets with a mold assembly according to the principles of the present invention.

### DETAILED DESCRIPTION OF THE PREFERRED EMBODIMENTS

Reference is now made in detail to the exemplary embodiments of the invention, examples of which are illustrated in the accompanying figures. Wherever possible, the same reference numbers are used throughout the figures to refer to the same or like parts.

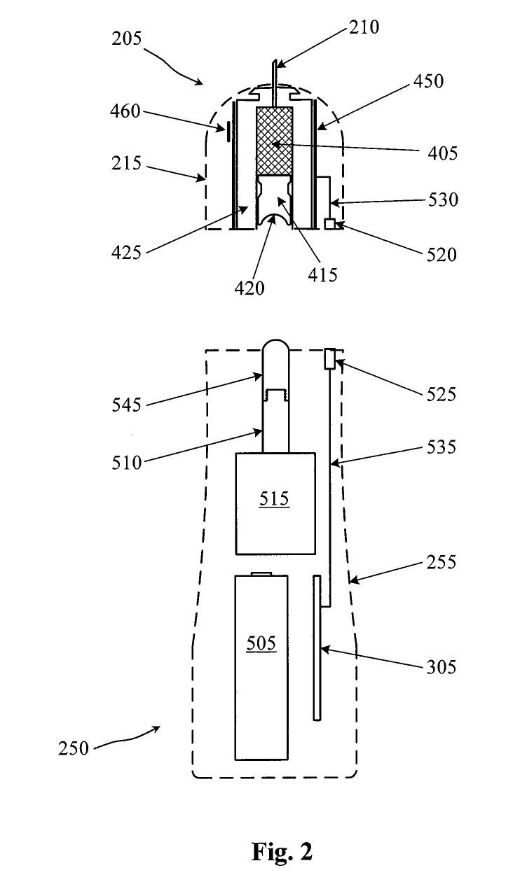

FIG. 2 is a cross section view of a disposable tip segment and a limited reuse assembly according to an embodiment of the present invention. FIG. 2 shows how tip segment 205 interfaces with limited reuse assembly 250. In the embodiment of FIG. 2, tip segment 205 includes plunger interface 420, plunger 415, dispensing chamber housing 425, tip segment housing 215, temperature control device 450, thermal sensor 460, needle 210, dispensing chamber 405, interface 530, and tip interface connector 520. Limited reuse assembly 250 includes mechanical linkage 545, actuator shaft 510, actuator 515, power source 505, controller 305, limited reuse assembly housing 255, interface 535, and limited reuse assembly interface connector 525.

In tip segment 205, plunger interface 420 is located on one end of plunger 415. The other end of plunger 415 forms one end of dispensing chamber 405. Plunger 415 is adapted to slide within dispensing chamber 405. An outer surface of plunger 415 is fluidly sealed to the inner surface of dispensing chamber housing 425. Dispensing chamber housing 425 surrounds the dispensing chamber 405. Typically, dispensing chamber housing 425 has a cylindrical shape. As such, dispensing chamber 405 also has a cylindrical shape.

Needle 210 is fluidly coupled to dispensing chamber 405. In such a case, a substance contained in dispensing chamber 405 can pass through needle 210 and into an eye. Temperature control device 450 at least partially surrounds dispensing chamber housing 425. In this case, temperature control device 450 is adapted to heat and/or cool dispensing chamber housing 425 and any substance contained in dispensing chamber 405. Interface 530 connects temperature control device 450 and thermal sensor 460 with tip interface connector 520.

The components of tip segment 205, including dispensing chamber housing 425, temperature control device 450, and plunger 415 are at least partially enclosed by tip segment housing 215. In one embodiment consistent with the principles of the present invention, plunger 415 is sealed to the interior surface of dispensing chamber housing 425. This seal prevents contamination of any substance contained in dispensing chamber 405. For medical purposes, such a seal is desirable. This seal can be located at any point on plunger 415 or dispensing chamber housing 425.

In limited reuse assembly 250, power source 505 provides power to actuator 515. An interface (not shown) between power source 505 and actuator 515 serves as a conduit for providing power to actuator 515. Actuator 515 is connected to actuator shaft 510. When actuator 515 is a stepper motor, actuator shaft 510 is integral with actuator 515. Mechanical linkage interface 545 is connected to actuator shaft 510. In this configuration, as actuator 515 moves actuator shaft 510 upward toward needle 210 mechanical linkage interface 545 also moves upward toward needle 210.

Controller 305 is connected via interface 535 to limited reuse assembly interface connecter 525. Limited reuse assembly interface connecter 525 is located on a top surface of limited reuse assembly housing 255 adjacent to mechanical linkage interface 545. In this manner, both limited reuse assembly interface connector 525 and mechanical linkage interface 545 are adapted to be connected with tip interface connector 520 and plunger interface 420 respectively.

Controller 305 and actuator 515 are connected by an interface (not shown). This interface (not shown) allows controller 305 to control the operation of actuator 515. In addition, an interface (not shown) between power source 505 and controller 305 allows controller 305 to control operation of power source of 310. In such a case, controller 305 may control the charging and the discharging of power source 505 when power source 505 is a rechargeable battery.

Controller 305 is typically an integrated circuit with power, input, and output pins capable of performing logic functions. In various embodiments, controller 305 is a targeted device controller. In such a case, controller 305 performs specific control functions targeted to a specific device or component, such as a temperature control device or a power supply. For example, a temperature control device controller has the basic functionality to control a temperature control device. In other embodiments, controller 305 is a microprocessor. In such a case, controller 305 is programmable so that it can function to control more than one component of the device. In other cases, controller 305 is not a programmable microprocessor, but instead is a special purpose controller configured to control different components that perform different functions. While depicted as one component, controller 305 may be made of many different components or integrated circuits.

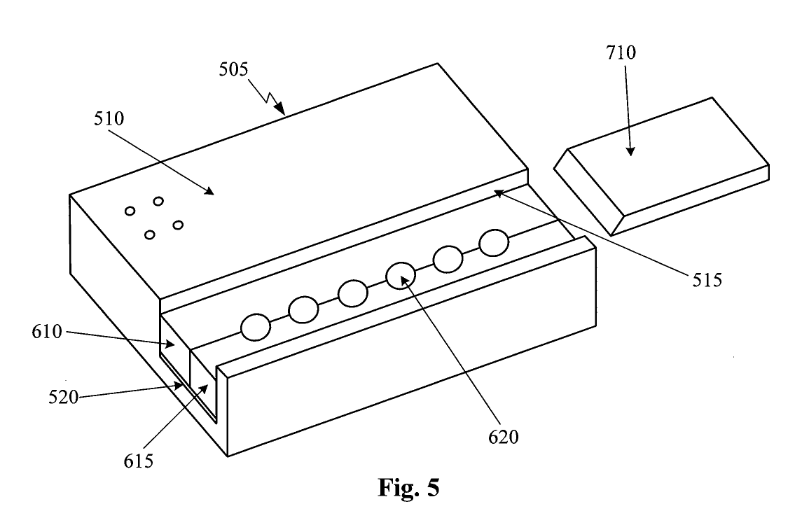

Tip segment 205 is adapted to mate with or attach to limited reuse assembly 250 as previously described. In the embodiment of FIG. 5, plunger interface 420 located on a bottom surface of plunger 415 is adapted to mate with mechanical linkage interface 545 located near a top surface of limited reuse assembly housing 255. In addition, tip interface connector 520 is adapted to connect with limited reuse assembly interface connector 525. When tip segment 205 is connected to limited reuse assembly 250 in this manner, actuator 515 and actuator shaft 510 are adapted to drive plunger 415 upward toward needle 210. In addition, an interface is formed between controller 305 and temperature control device 450. A signal can pass from controller 305 to temperature control device 450 through interface 535, limited reuse assembly interface connector 525, tip interface connector 520, and interface 530.

In operation, when tip segment 205 is connected to limited reuse assembly 250, controller 305 controls the operation of actuator 515. Actuator 515 is actuated and actuator shaft 510 is moved upward toward needle 210. In turn, mechanical linkage interface 545, which is mated with plunger interface 420, moves plunger 415 upward toward needle 210. A substance located in dispensing chamber 405 is then expelled through needle 210.

In addition, controller 305 controls the operation of temperature control device 450. Temperature control device 450 is adapted to heat and/or cool dispensing chamber housing 425. Since dispensing chamber housing 425 is at least partially thermally conductive, heating or cooling dispensing chamber housing 425 heats or cools a substance located in dispensing chamber 405. Temperature information can be transferred from thermal sensor 460 to controller 305 via any of a number of different interface configurations. This temperature information can be used to control the operation of temperature control device 450. When temperature control device 450 is a heater, controller 305 controls the amount of current that is sent to temperature control device 450. The more current sent to temperature control device 450, the hotter it gets. In such a manner, controller 305 can use a feed back loop utilizing information from thermal sensor 460 to control the operation of temperature control device 450. Any suitable type of control algorithm, such as a proportional integral derivative (PID) algorithm, can be used to control the operation of temperature control device 450.

In various embodiments of the present invention, temperature control device 450 heats a phase transition compound that is located in dispensing chamber 405. This phase transition compound carries a drug that is to be injected into the eye. A phase transition compound is in a solid or semi-solid state at lower temperatures and in a more liquid state at higher temperatures. Such a substance can be heated by temperature control device 450 to a more liquid state and injected into the eye where it forms a bolus that erodes over time. Likewise, a reverse gelation compound may be used. A reverse gelation compound is in a solid or semi-solid state at higher temperatures and in a more liquid state at lower temperatures. Such a compound can be cooled by temperature control device 450 to a more liquid state and injected into the eye where it forms a bolus that erodes over time. As such, temperature control device 450 may be a device that heats a substance in dispensing chamber 405 or a device that cools a substance in dispensing chamber 405 (or a combination of both). After being delivered into the eye, a phase transition compound or reverse gelation compound erodes over time providing a quantity of drug over an extended period of time. Using a phase transition compound or reverse gelation compound provides better drug dosage with fewer injections.

FIG. 5 is a perspective view of mold assembly according to the principles of the present invention. In FIG. 5, mold base plate 505 includes a mounting portion 510, a recess 515, and a bottom plate 520. Mounting portion 510 is configured to mount mold base plate 505 on a surface. Recess 515 holds the mold itself. Mounting portion 510 is also configured to hold the mold. Mounting portion 510 may have mounting holes as shown for holding a clamp or other retention device (not shown) that holds the mold in place. Bottom plate 520 forms the bottom boundary of the mold. Mold base plate 505 is preferably made of a thermally conductive material such as aluminum or copper. Bottom plate 520 is preferably made of a thermally conductive material that is approved for contact with a drug. For example, bottom plate 520 may be made of glass, a polymer, or other like materials. In other embodiments, the surface of bottom plate 520 that contacts the drug is coated with such a material.

The molding portion includes a first section 610 and a second section 615. These two sections fit together to form a set of generally cylindrical cavities, such as cavity 620. A drug suspended in a phase transition compound or reverse gelation compound is poured into the cavities. First section 610 and second section 615 are preferably made of a thermally conductive material that is approved for contact with a drug. For example, first section 610 and second section 615 may be made of glass, a polymer, or like material. In other embodiments, the surface of first section 610 and second section 615 that contacts the drug is coated with such a material.

In FIG. 5, first section 610 and second section 615 are located on top of base plate 520. In this configuration, a drug suspended in a compound is brought to a more liquid state and poured into the cavities, such as cavity 620. A temperature controlled scraper 710 is then moved across the top surface of mold 605. This scraper 710 is designed to fit on top of mold 605. The drug and compound are then brought to a more solid state, the mold is removed from the mold base plate 505, the two sections 610, 615 are separated, and the drug pellets are removed.

For example, pellets can be made from a drug suspended in a phase transition compound. In such a case, the mold assembly of FIG. 5 is prepared for use. First section 610 and second section 615 are placed together and clamped into recess 515 so that bottom plate 520 is flush with the bottom of mold 605. In this position, bottom plate 520 forms a fluid tight seal against the bottom of mold 605. The mold assembly of FIG. 5 is then heated. In such a case, the mold assembly is coupled to a heater (not shown). The mixture of drug and phase transition compound is also heated so that it is in a more liquid state. The drug/compound mixture is poured into the cavities of the mold, such as cavity 620. The drug/compound mixture is poured slowly such that bubbles are not entrapped. In addition, the mixture overfills the cavities since there is some shrinkage when the mixture cools. The mold assembly is then cooled so that the drug/compound mixture cools and solidifies. The temperature controlled scraper 710 (which is heated and may be coupled to a heater) is drawn across the top surface of mold 605 to remove any excess drug/compound from the top surface. The scraper 710 also smoothes the top surface of the pellets. The first section 610 and second section 615 are removed from recess 515 and separated. The resulting pellets are then ready to be placed into an injection device.

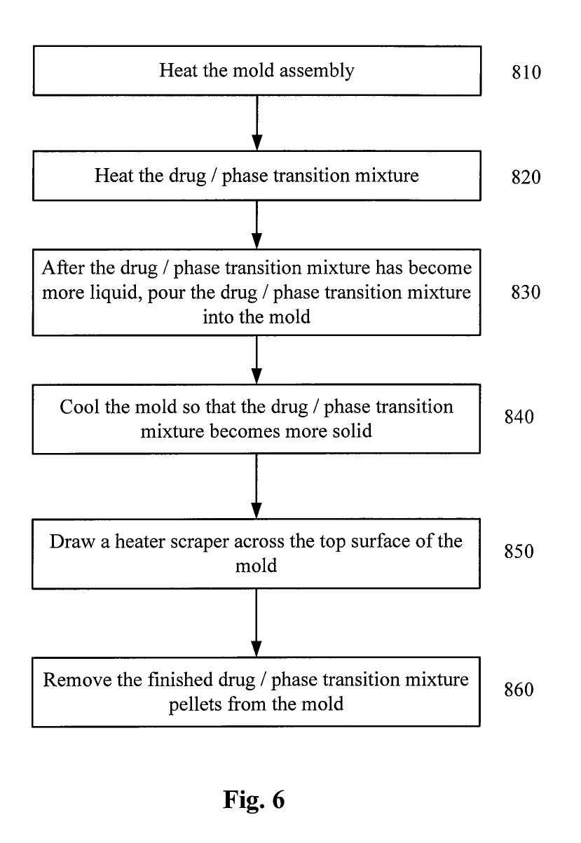

FIG. 6 is a flow chart of a method of molding pellets with a mold assembly according to the principles of the present invention. In 810, the mold assembly (which includes both sections 610 and 615, and the mold base plate 505) is heated. In 820, the drug/phase transition compound mixture is heated. In 830, after the drug/phase transition compound has become more liquid, it is poured into the mold. In 840, the mold containing the drug/phase transition mixture is cooled until the mixture becomes more solid. In 850, a heated scraper is drawn across the top surface of the mold. In 860, the finished pellets are removed from the mold.

From the above, it may be appreciated that the present invention provides an improved system for preparing drug dosages. The present invention provides a mold assembly that includes a base plate and a mold. This assembly is configured to form pellets from a drug/compound mixture that is solid at room temperature but liquid at other temperatures. The finished pellets are of the proper size to produce a reliable dosage when injected into the eye.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A mold assembly comprising:
a mold base plate comprising a bottom plate located in a recess; and
a mold that can be inserted into and removed from the recess and located on top of the bottom plate, the mold comprising a first section and a second section, the first section separable from the second section;
wherein when the first section and the second section are located adjacent to each other in the recess, a plurality of cavities is formed, each cavity for receiving a quantity of a drug and compound mixture when the mold base plate and mold are at a temperature other than room temperature.

2. The assembly of claim 1 further comprising:
a temperature controlled scraper slidable over a top surface of the mold.

3. The assembly of claim 1 wherein the bottom plate and mold are made of a material that is approved for contact with a drug.

4. The assembly of claim 1 wherein the bottom plate is made of a material selected from the group consisting of glass and polymer.

5. The assembly of claim 1 wherein the mold base plate is made of a thermally conductive material.

6. The assembly of claim 1 further comprising:
a heater for heating the mold and mold base plate.

7. The assembly of claim 6 further comprising:
a temperature controlled scraper slidable over a top surface of the mold; and
a second heater coupled to the scraper, the heater for heating the scraper.

8. The assembly of claim 1 wherein the mold base plate further comprises:
a retention device for holding the mold in place; and
mounting holes for mounting the retention device on the mold base plate.

9. A mold assembly comprising:
a mold base plate comprising a bottom plate located in a recess;
a mold that can be inserted into and removed from the recess and located on top of the bottom plate, the mold comprising a first section and a second section, the first section separable from the second section;
a first heater for heating the mold base plate;
a retention device for holding the mold in the recess;
mounting holes for mounting the retention device on the mold base plate;
a temperature controlled scraper slidable over a top surface of the mold; and
a second heater coupled to the scraper, the heater for heating the scraper;
wherein when the first section and the second section are located adjacent to each other in the recess, a plurality of cavities is formed, each cavity for receiving a quantity of a drug and compound mixture when the mold base plate and mold are heated.

10. The assembly of claim 9 wherein the bottom plate and mold are made of a material that is approved for contact with a drug.

11. The assembly of claim 9 wherein the bottom plate is made of a material selected from the group consisting of glass and polymer.

12. The assembly of claim 9 wherein the mold base plate is made of a thermally conductive material.

13. A method of making drug/compound pellets comprising:
heating a mold assembly;
heating a mixture of a drug and phase transition compound;
after the mixture has become more liquid, pouring the mixture into the mold;
cooling the mold so that the mixture becomes more solid;
drawing a heated scraper across the top surface of the mold; and
removing finished pellets from the mold.

14. The method of claim 13 further comprising:
loading the finished pellets into an injection device.

15. The method of claim 13 wherein pouring the mixture into the mold further comprises pouring the mixture into the mold such that air bubbles are not entrapped in the mixture.

16. The method of claim 13 wherein pouring the mixture into the mold further comprises overfilling the mold with mixture.

17. The method of claim 13 further comprising:
assembling the mold assembly by placing two sections of a mold into a recess in a mold base plate.

18. The method of claim 17 further comprising:
clamping the mold into the recess to form a fluid tight seal between a bottom surface of the mold and a bottom plate.
